(19) United States
(12) Patent Application Publication
(10) Pub. No.: US 2016/0125770 A1
(43) Pub. Date: May 5, 2016

(54) Display Apparatus And Computer Readable Medium

(71) Applicant: CASIO COMPUTER CO., LTD., Shibuya-ku (JP)

(72) Inventors: Shunsuke HARA, Fuchu-shi (JP); Takeo ISHIZU, Higashimurayama-shi (JP); Yuji ABE, Komae-shi (JP); Yoichi MURAYAMA, Fussa-shi (JP); Atsushi SHIBUTANI, Tokorozawa-shi (JP); Gou KAWAKAMI, Fussa-shi (JP)

(73) Assignee: CASIO COMPUTER CO., LTD., Tokyo (JP)

(21) Appl. No.: 14/858,364

(22) Filed: Sep. 18, 2015

(30) Foreign Application Priority Data
Oct. 30, 2014 (JP) 2014-221132

(51) Int. Cl. G09F 9/302; G09G 3/00

(52) U.S. Cl. CPC G09F 9/302; G09G 3/003; G09G 2380/06

(57) ABSTRACT

A display apparatus includes a screen, a setting unit and a processor. The setting unit is for setting a product and is provided at the screen. The processor controls display on the screen on a basis of the product which is set at the setting unit.

### CROSS-REFERENCE TO RELATED APPLICATIONS

This application is based upon and claims the benefit of priority under 35 USC 119 of Japanese Patent Application No. 2014-221132 filed on Oct. 30, 2014 the entire disclosure of which, including the descriptions, claims, drawings, and abstracts, is incorporated herein by reference in its entirety.

### BACKGROUND OF THE INVENTION

1. Field of the Invention

The present invention relates to a display apparatus and a computer readable medium.

2. Description of Related Art

Conventionally, there is known an apparatus in which an image output device is installed, the apparatus including the image output device to be connected to an image supplying device, a reflecting member and a screen, which reflects the output light that projects contents from the image output device on the reflecting member and projects the output light reflected off the reflecting member on the screen (for example, see JP 2011-150221). Such an apparatus is used for showing and describing products at stores, exhibitions, etc., for example.

However, the apparatus in which an image output device is installed of JP 2011-150221 merely projects predetermined contents and does not display contents related to the actual product which a user is looking at.

### SUMMARY OF THE INVENTION

An object of the present invention is to realize a display based on an actual product which a user is looking at.

According to a first aspect of the present invention, there is provided a display apparatus, including a screen; a setting unit where a product is to be set, the setting unit being provided at the screen; and a processor which controls display on the screen on a basis of the product which is set at the setting unit.

### BRIEF DESCRIPTION OF THE DRAWINGS

The present invention is fully understood from the detailed description given hereafter and the accompanying drawings, which are given by way of illustration only and thus are not intended to limit the present invention, wherein:

FIG. 1 is a front view diagonally showing an outline structure of the entire digital signage apparatus of the present embodiment;

FIG. 2 is a block diagram showing a main control structure of the digital signage apparatus of FIG. 1;

FIG. 3 is a schematic view of a cross-section including a three-dimensional part when a screen of FIG. 1 is seen from above;

FIG. 4 is a view for describing an example of a product discriminator of FIG. 2;

FIG. 5A is a view for describing another example of the product discriminator of FIG. 2;

FIG. 5B is a view for describing another example of the product discriminator of FIG. 2;

FIG. 6 is a flowchart showing a content output process which is executed by a processor of FIG. 2;

FIG. 7 is a view for describing step S7 of FIG. 6;

FIG. 8 is a view showing another example of the screen;

FIG. 9A is a view showing another example of the screen; and

FIG. 9B is a view showing an example where a product is set at the screen of FIG. 9A.

### DESCRIPTION OF THE PREFERRED EMBODIMENTS

Hereinafter, a preferable embodiment of the present invention will be described in detail with reference to the drawings. In the following embodiment, an example where a digital signage apparatus 1 is used as a display apparatus according to the present invention will be described. However, the present invention is not limited to the example shown in the drawings.

### [Structure of the Digital Signage Apparatus 1]

The digital signage apparatus 1 is set at a store or the like, for example, and outputs contents such as product description, etc. for a user.

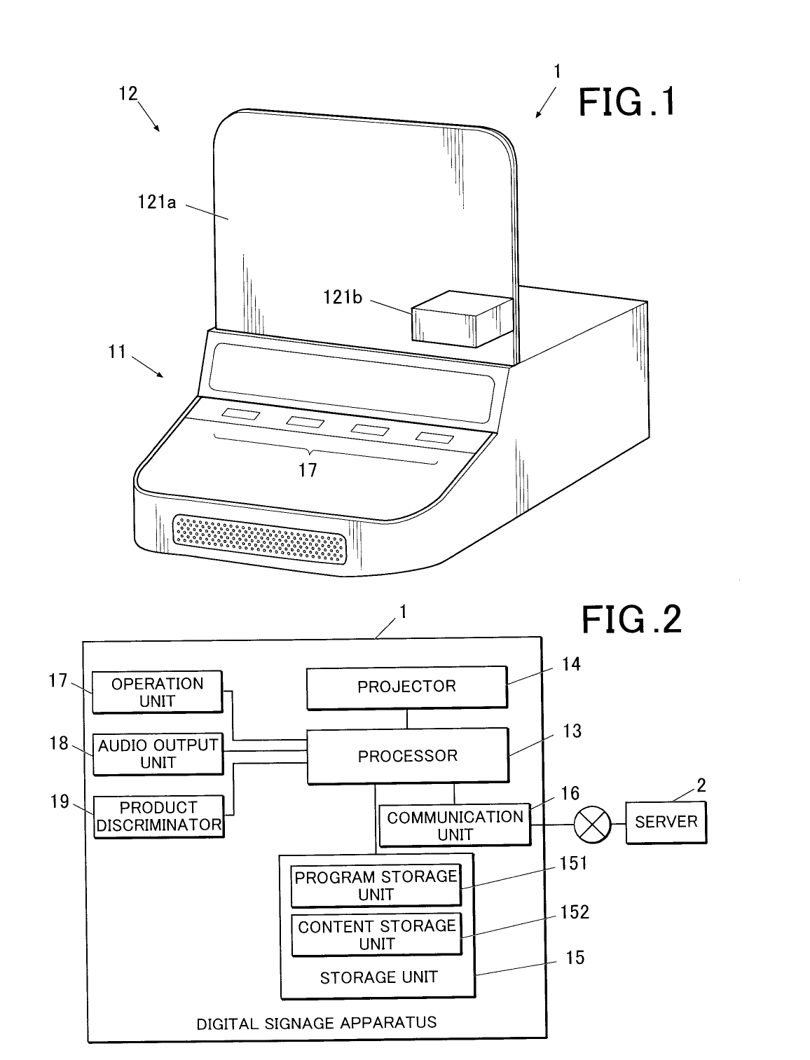

FIG. 1 is a front view diagonally showing an outline structure of the entire digital signage apparatus 1. FIG. 2 is a block diagram showing the main control structure of the digital signage apparatus 1.

As shown in FIG. 1, the digital signage apparatus 1 includes a main body unit 11 and a screen 12. The screen 12 is attached to the main body unit 11. Further, the main body unit 11 includes a processor 13, a projector 14, a storage unit 15, a communication unit 16, an operating unit 17, an audio output unit 18 and a product discriminator 19 which are shown in FIG. 2. As shown in FIG. 2, the projector 14, the storage unit 15, the communication unit 16, the operating unit 17, the audio output unit 18 and the product discriminator 19 are connected to the processor 13.

The screen 12 receives projection light which is emitted from the projector 14 with its back surface and projects the projection light toward the front.

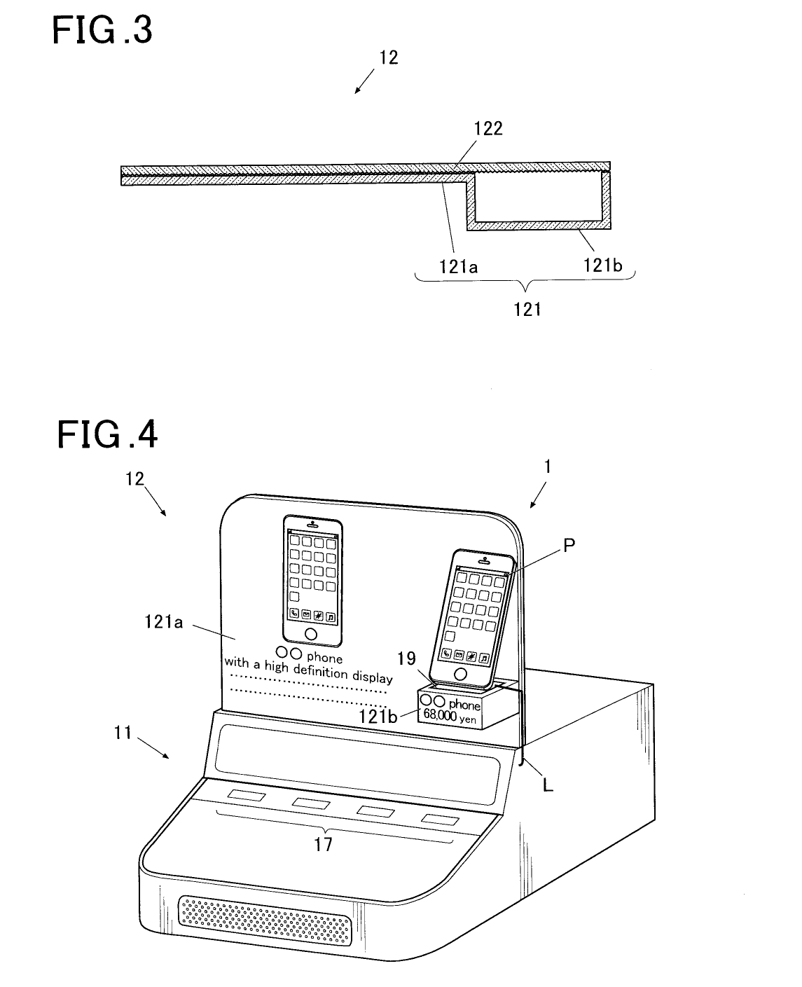

FIG. 3 is a schematic view of a cross-section including a three-dimensional part 121b when the screen 12 is seen from above. As shown in FIG. 3, the screen 12 includes a diffuse transmission unit 121 which is formed of an acrylic plate, for example, and a Fresnel lens 122 which is disposed on the back surface side of the diffuse transmission unit 121.

The diffuse transmission unit 121 includes a flat board part 121a which is formed in a flat board shape and a three-dimensional part 121b which is formed three-dimensionally so as to project toward the front. The flat board part 121a is, for example, a display unit where various information relating to a product P is to be shown, and is formed in a flat board shape so as to assure visibility. The three-dimensional part 121b is hollow inside and the back surface side is opened.

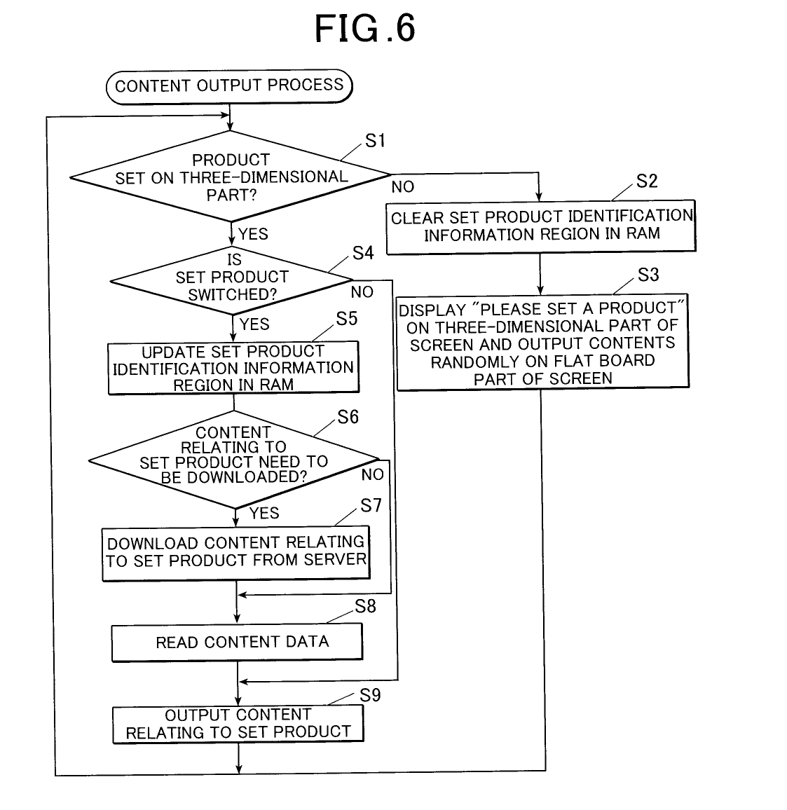

In the present embodiment, the three-dimensional part 121b is formed in a shelf-like shape where a product P can be set configuring a setting unit for setting a product P as shown in FIG. 1. In particular, as shown in FIG. 1, the three-dimensional part 121b projects toward the front and the upper surface thereof is a flat surface so that a product P can be set. When a product P is set on the three-dimensional part 121b, the content related to the product P set on the three-dimensional part 121b is to be output (see FIG. 6). The detail will be described later.

The Fresnel lens 122 is disposed on the back surface side of the diffuse transmission unit 121. The Fresnel lens 122 refracts the projection light which is projected from the projector 14 by a predetermined degree and converts the projection light into parallel light that is approximately orthogonal to the imaginary flat surface that faces the screen 12 (an imaginary position of a user facing the screen 12), and guides the projection light toward the diffuse transmission unit 121. In such way, an image with reduced distortion can be displayed on the screen 12 including the three-dimensional part 121b even if the original image data is not adjusted.

The processor 13 includes a CPU (Central Processing Unit) which executes various types of programs stored in the program storage unit 151 of the storage unit 15 to carry out predetermined arithmetic operation and various control and a memory which is used as the working region when executing the programs (both are not shown in the drawings). The processor 13 executes the after-mentioned content output process by cooperating with the programs stored in the program storage unit 151 of the storage unit 15.

The projector 14 is a projecting device which converts the image data output from the processor 13 into projection light and emits the projection light toward the back surface of the screen 12. As for the projector 14, for example, a DLP (Digital Light Processing) (registered trademark) projector which utilizes DMD (digital micro-mirror device) that is a display device which performs display operation by individually turning on/off the tilting angles of a plurality of micro-mirrors that are arrange in an array (in the case of XGA, 1024 pixels horizontally×768 pixels vertically) and forms a light image with the reflection light thereof.

The storage unit 15 includes a HDD (Hard Disk Drive), a nonvolatile semiconductor memory or the like. As shown in FIG. 2, the storage unit 15 includes the program storage unit 151. In the program storage unit 151, the system program that is to be executed in the processor 13, process programs for executing various types of processes including the after-mentioned content output process, data necessary for executing these programs, etc. are stored.

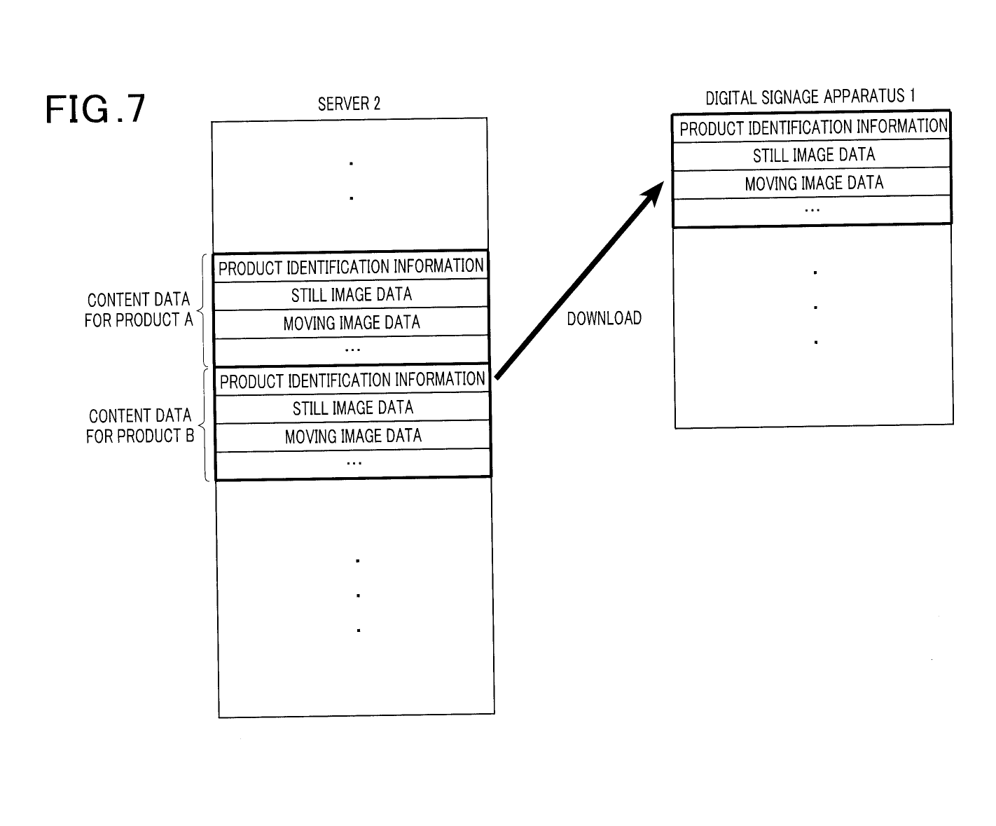

Further, the storage unit 15 is provided with a content storage unit 152. In the content storage unit 152, content data for outputting contents to the screen 12 and the like is stored. In the present embodiment, contents are used for describing a product, and each content data includes product identification information, still image data (for example, display data such as product name, price, etc. to be displayed in the three-dimensional part 121b of the screen 12), moving image data (moving image data for product description to be displayed in the flat board part 121a of the screen 12 including frame image data and audio data) (for example, see FIG. 7).

The communication unit 16 includes a modem, router, network card or the like. The communication unit 16 communicates with external devices such as a server 2 connected to the communication network including LAN (Local Area Network), WAN (Wide Area Network) and the like. In the server 2, content data of each product P sold in a store where the digital signage apparatus 1 is set is stored (see FIG. 7). Here, the communication method with external devices can be via cable (wire) communication or wireless communication.

The operating unit 17 includes an operating button, for example, and detects a pressed signal of the operating button and outputs a corresponding signal to the processor 13.

The audio output unit 18 converts the audio data designated by the processor 13 into an audio signal and outputs the audio from the speaker.

The product discriminator 19 discriminates the product P which is placed on the three-dimensional part 121b of the screen 12. In the present embodiment, each product P has a recording medium (for example, IC tag, barcode, etc.) which records product identification information such as a product ID attached thereto in advance, and the product discriminator 19 reads the product identification information from the recording medium and outputs the information to the processor 13.

The product discriminator 19 can be configured of a RFID (Radio Frequency IDentification) reader such as a NFC (Near Field Communication) reader, for example. In such case, as shown in FIG. 4, the product discriminator 19 is disposed on the upper surface of the three-dimensional part 121b and reads the product identification information from the IC tag (RFID tag) which is associated with the product P set on the three-dimensional part 121b. The wiring L for sending the read product identification information to the processor 13 from the product discriminator 19 is wired along the frame (edge) part of the screen 12 as shown in FIG. 4. In a case where the three-dimensional part 121b is far from the frame of the screen 12, the wiring L extending from the product discriminator 19 to the frame of the screen 12 can be wired between the diffuse transmission unit 121 and the Fresnel lens 122 of the screen 12. Alternatively, both the product discriminator 19 and the processor 13 can be connected to a wireless communication unit such as Bluetooth (registered trademark) and Wi-Fi (registered trademark), and the product identification information can be sent to the processor 13 from the product discriminator 19 via wireless communication.

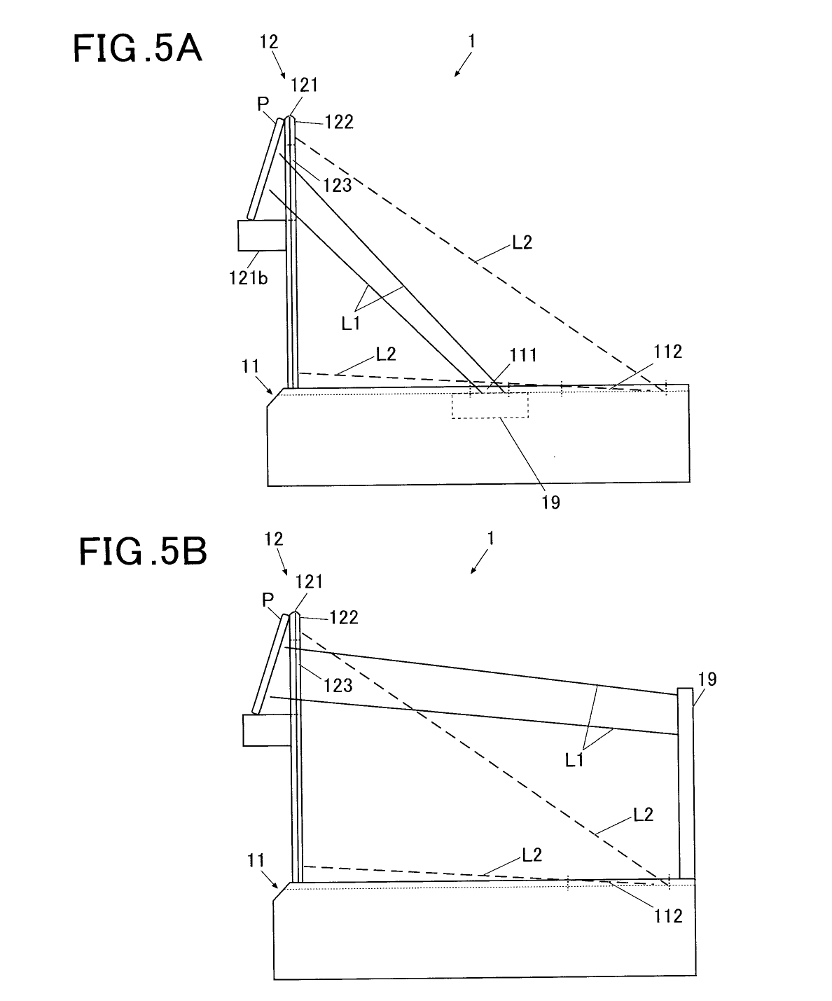

Moreover, the product discriminator 19 can be configured of a laser-type barcode scanner, for example. In such case, for example, the product discriminator 19 is installed inside the case of the main body unit 11 as shown in the side view of FIG. 5A. In a case where a product P is set on the three-dimensional part 121b, an opening part 123 for passing though the laser L1 from the product discriminator 19 is formed at the part facing the part of the product P placed on the three-dimensional part 121b where the barcode indicating the product identification information of the produce P is attached so that the laser L1 from the product discriminator 19 and the reflection light from the barcode (both not shown) can pass through the opening part 123. In the panel covering the upper surface of the case of the main body unit 11, a barcode window 111 for the laser L1 from the product discriminator 19 and the reflection light from the barcode to pass through is formed (different from the projection light window 112). In such way, the product discriminator 19 can read the barcode of the product P which is set on the three-dimensional part 121b.

Alternatively, as shown in the side view of FIG. 5B, a laser-type barcode scanner can be provided at the position on the back surface side of the main body unit 11 facing the three-dimensional part 121b as the product discriminator 19, and the barcode of the product P can be read by the product discriminator 19 emitting the laser L1 toward the opening part 123.

The barcode to be associated with the product P can be a one-dimensional code or a two-dimensional code such as QR code (registered trademark), and it is not limited in any way.

### [Operation of the Digital Signage Apparatus 1]

Next, operation of the digital signage apparatus 1 will be described.

FIG. 6 shows a flowchart of the content output process which is to be executed in the digital signage apparatus 1. The content output process is executed by the processor 13 and the programs stored in the program storage unit 151 cooperating with each other when the power of the digital signage device 1 is turned on.

In the content output process, first, the processor 13 determines whether a product P is set on the three-dimensional part 121b of the screen 12 (step S1). For example, the processor 13 makes the product discriminator 19 read the product identification information, and if the product identification information is read, the processor 13 determines that a product P is set on the three-dimensional part 121b. If the product identification information is not read, the processor 13 determines that a product P is not set on the three-dimensional part 121b.

If the processor 13 determines that a product P is not set on the three-dimensional part 121b (step S1; NO), the processor 13 clears the information in the set product identification information region in the RAM (step S2). Then, the processor 13 displays a message such as “please set a product” at the three-dimensional part 121b and randomly outputs contents based on the content data stored in the content storage unit 152 by the flat board part 121a of the screen 12 and the audio output unit 18 (step S3), and then, returns to step S1. In particular, the processor 13 reads out the content data of the content to be output from the content storage unit 152, superimposes the above message at the position in each frame image of the moving image data corresponding to the position of the three-dimensional part 121b, and sequentially outputs the frame images to the projector 14 to be projected on the screen 12 by the projector 14. Further, the processor 13 outputs the audio data of the read content data to the audio output unit 18 and makes the audio output unit 18 output the audio of the content.

If the processor 13 determines that a product P is set on the three-dimensional part 121b (step S1; YES), the processor 13 determines whether the product P (set product) which is set on the three-dimensional part 121b is switched (step S4). For example, the processor 13 compares the product identification information newly obtained by the product discriminator 19 to the product identification information stored in the set product identification information region of the RAM. If the identification information matches, the processor 13 determines that the product P is not switched. If the identification information does not match, the processor 13 determines that the product P was switched. If there is no information stored in the set product identification information region of the RAM (if switched to the state where a product P is set from the state where a product P is not set), the processor 13 also determines that the product P was switched.

If the processor 13 determines that the product P set in the three-dimensional part 121b is not switched (step S4; NO), the processor 13 proceeds to step S9.

If the processor 13 determines that the product P set on the three-dimensional part 121b was switched (step S4; YES), the processor 13 updates the information in the set product identification information region of the RAM with the newly obtained product identification information (step S5).

Next, the processor 13 determines whether the content relating to the product P which is set on the three-dimensional part 121b needs to be downloaded (step S6). In particular, the processor 13 determines whether the content needs to be downloaded based on whether the content data including the product identification information read from the product P set on the three-dimensional part 121b is stored in the content storage unit 152.

If the processor 13 determines that there is no need to download the content (step S6; NO), the processor 13 reads the content data including the product identification information read from the product P set on the three-dimensional part 121b from the content storage unit 152, that is, the content data relating to the product P set on the three-dimensional part 121b, and then proceeds to step S9.

If the processor 13 determines that there is a need to download the content (step S6; YES), the processor 13 sends the product identification information read from the product P which is set on the three-dimensional part 121b by the product discriminator 19 to the server 2 by the communication unit 16 and downloads the content relating to the product P set on the three-dimensional part 121b from the server 2 (step S7).

FIG. 7 schematically shows the process of step S7. As shown in FIG. 7, the content data relating to each product P stored in the server 2 includes the product identification information, still image data (for example, display data such as the product name, price, etc. to be displayed in the three-dimensional part 121b of the screen 12) and moving image data (moving image data for product description including frame image data and audio data). The digital signage apparatus 1 downloads the content data relating to the product P set on the three-dimensional part 121b all at once.

Then, the processor 13 reads the content data which is downloaded (step S8) and proceeds to step S9.

In step S9, the processor 13 makes the screen 12 and the audio output unit 18 output the content relating to the product P set on the three-dimensional part 121b (step S9) and returns to step S1.

For example, in step S9, the processor 13 superimposes the still image data of the read content at a position in each frame image of the moving image data that corresponds to the position of the three-dimensional part 121b, sequentially outputs the frame images to the projector 14 and projects the frame images on the screen 12 by the projector 14. Further, the processor 13 makes the audio output unit 18 output the audio corresponding to the moving image data. In such way, as shown in FIG. 4, the product name, price and the like of the product P set on the three-dimensional part 121b by a user can be displayed at the three-dimensional part 121b of the screen 12. Further, a moving image of detailed description and the like of the product P can be displayed on the flat board part 121a of the screen 12.

The processor 13 repeats the process of step S1 to step S9 until the power of the digital signage apparatus 1 is turned off.

As described above, according to the digital signage apparatus 1, the screen 12 includes the flat board part 121a and the three-dimensional part 121b, and the processor 13 controls the display in the screen 12 on the basis of the product P which is set on the three-dimensional part 121b.

Therefore, by setting the product P which a user is interested in after looking at the actual product on the three-dimensional part 121b of the screen 12, a display based on the actual product P at which the user is actually looking with interest can be provided.

For example, by displaying the information relating to the set product P at the three-dimensional part 121b as the setting unit of the product P, the information relating to the product P can be displayed near the product P which is set. The user can easily confirm the information relating to the product P set on the three-dimensional part 121b.

The discrimination of the product P which is set on the three-dimensional part 121b can be carried out easily by, for example, reading the RFID tag or the barcode which records the identification information of the product P with the product discriminator 19 configured of a RFID reader or a barcode reader.

The above description of the embodiment is a preferred example of the digital signage apparatus according to the present invention, and the present invention is not limited to the above embodiment in any way.

For example, in the above embodiment, an example where the three-dimensional part 121b for setting a product P is formed in a shelf-like shape is described. However, the three-dimensional part 121b is not limited to this shape.

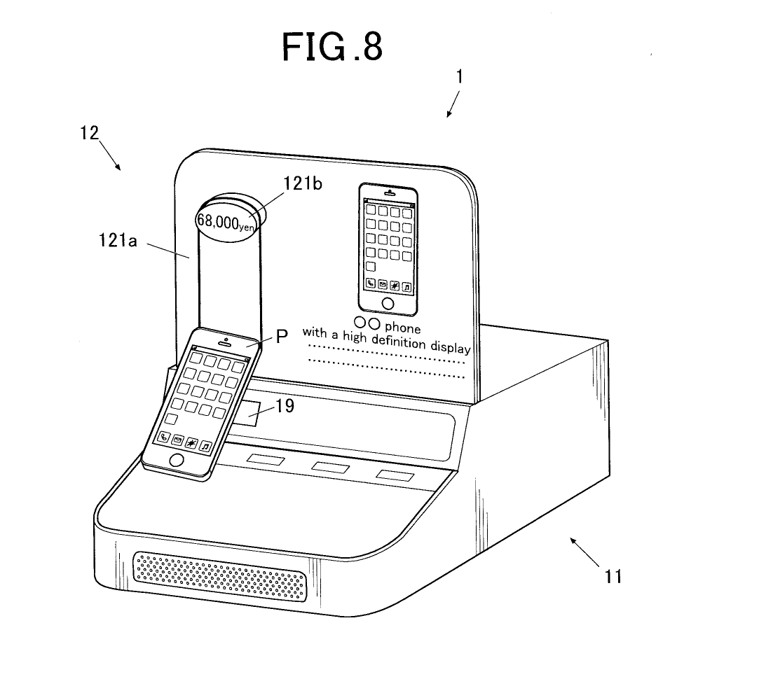

For example, the three-dimensional part 121b can be formed in a cylindrical shape that projects so that a product P can be hung as shown in FIG. 8. The product P can be set at the three-dimensional part 121b by being hung on the three-dimensional part 121b by a string or the like. In such case, the product discriminator 19 can be a RFID reader (for example, a NFC reader, etc.) which is provided on the front surface of the main body unit 11, for example. Then, by reading the product identification information from the RFID tag associated with the product P, the RFID tag being the recording medium recording the product identification information, with the product discriminator 19, the product P set at the three-dimensional part 121b can be discriminated.

Further, a space can be provided at the three-dimensional part 121b when forming the screen 12 so that a product P can be set in the space.

Furthermore, in a case where the product P is something to be worn on a face such as eye-glasses, accessories, etc., the three-dimensional part 121b can be formed in a face shape so that the product P can be worn on the face-shaped three-dimensional part 121b, for example. The main body unit 11 can be provided with an image pickup unit which picks up a face image of a user, and the face of a user can be picked up by the image pickup unit and the face image of the user can be projected on the three-dimensional part 121b of the screen 12. In such way, by setting a product P (eye-glasses, etc.) at the three-dimensional part 121b of the screen 12, the state where the user is wearing the eye-glasses can be seen objectively.

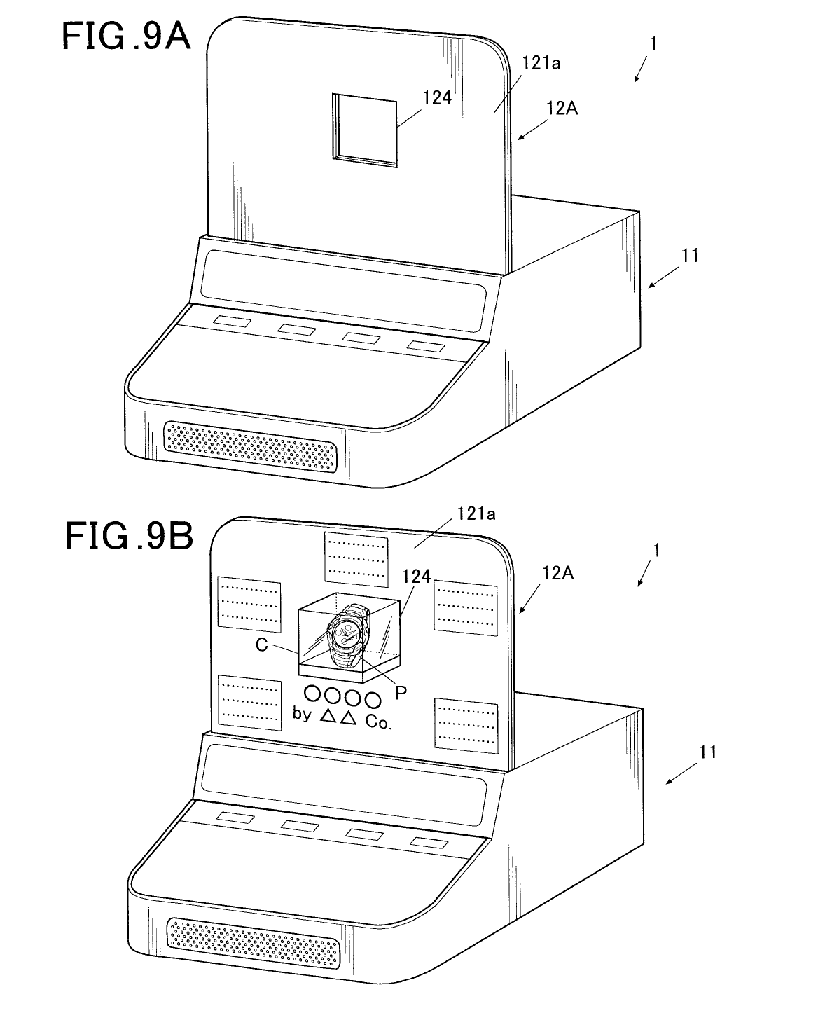

The setting unit for setting a product P is not limited to a screen provided with the three-dimensional part 121b. The setting unit can be formed in a screen (flat screen 12A) which only has the flat board part 121a. For example, an opening part 124 for setting a product P can be formed when forming the flat screen 12A as shown in FIG. 9A, and the product P can be set by placing the product P in a transparent case C or the like and fitting the case C containing the product P in the opening part 124. In such case, a laser-type barcode scanner or the like can be used as the product discriminator 19, for example. For example, a barcode indicating the product identification information can be attached on the back surface of the transparent case C, and the product P can be discriminated by reading this barcode with the laser-type barcode scanner of the product discriminator 19 provided at the main body unit 11 on the back surface side of the screen 12A as shown in FIGS. 5A and 5B. The processor 13 controls so that the content relating to the product P which is discriminated by the product discriminator 19 be displayed in the area around the opening part 124 of the screen 12A. By having such configuration, the actual product P can be displayed in the screen 12A and the information relating to the displayed product P can be displayed therearound. The setting unit may be formed at the position that overlaps the display area of the screen.

In the embodiment, content data of each product P which is sold in the store where the digital signage apparatus 1 is set is stored in the server 2, and the content data that does not exist in the content storage unit 15 is to be downloaded from the server 2 by the communication unit 16. However, content data may be stored in a large capacity memory card, for example. The content data that does not exist in the content storage unit 152 may be obtained from the memory card. Data can be obtained from the memory card by, for example, the digital signage apparatus 1 being provided with a card slot and reading data from the memory card inserted in the card slot or the data can be read through wireless communication if the memory card has the wireless LAN function.

Other than the above, the detail structure and the detail operation of the digital signage apparatus can also be changed as needed within the scope of the present invention.

Although various exemplary embodiments have been described above, the scope of the invention is not limited to the above described embodiments. The scope of the present invention is intended to include the scope of the claims and their equivalents.

What is claimed is:

1. A display apparatus, comprising:
a screen;
a setting unit where a product is to be set, the setting unit being provided at the screen; and
a processor which controls display on the screen on a basis of the product which is set at the setting unit.

2. The display apparatus of claim 1, wherein the screen includes a three-dimensional part, and the three-dimensional part configures the setting unit.

3. The display apparatus of claim 2, wherein the processor controls the screen to display information relating to the product which is set at the setting unit on the three-dimensional part of the screen.

4. The display apparatus of claim 1, wherein the screen includes an opening part, and the opening part configures the setting unit.

5. The display apparatus of claim 4, wherein the processor controls the screen to display information relating to the product which is set at the setting unit in an area around the opening part of the screen.

6. The display apparatus of claim 1, comprising a product discriminator which discriminates the product which is set at the setting unit, wherein
the processor controls the display on the screen on a basis of the product which is discriminated by the product discriminator.

7. The display apparatus of claim 6, wherein
identification information of the product which is set at the setting unit is associated with the product, and
the product discriminator discriminates the product which is set at the setting unit by reading the identification information of the product which is set at the setting unit.

8. A display apparatus, comprising:
a screen;
a setting unit where a product is to be set, the setting unit being provided at a position corresponding to a display area of the screen; and
a processor which controls display on the screen on a basis of the product set at the setting unit which is provided at the position corresponding to the display area of the screen.

9. A computer readable medium for causing a computer which is used in a display apparatus including a screen and a setting unit which is provided at the screen and which is for setting a product to accomplish:
a detection to detect the product set at the setting unit provided at the screen; and
a processing to control display on the screen on a basis of the product.

10. A computer readable medium for causing a computer which is used in a display apparatus including a screen and a setting unit which is provided at a position corresponding to a display area of the screen and which is for setting a product to accomplish:
a detection to detect the product set at the setting unit provided at the position corresponding to the display area of the screen; and
a processing to control display on the screen on a basis of the product.
